(19) United States
(12) Patent Application Publication
(10) Pub. No.: US 2010/0149223 A1
(43) Pub. Date: Jun. 17, 2010

(54) SELECTIVE DIMMING OF OLED DISPLAYS

(75) Inventor: Jonathan Betts-LaCroix, San Francicso, CA (US)

Correspondence Address: Trellis Intellectual Property Law Group, PC, 1900 EMBARCADERO ROAD, SUITE 109, PALO ALTO, CA, 94303, US

(73) Assignee: OQO, INC., San Francisco, CA (US)

(21) Appl. No.: 12/538,846

(22) Filed: Aug. 10, 2009

Related U.S. Application Data
(60) Provisional application No. 61/087,632, filed on Aug. 8, 2008.

(51) Int. Cl. G09G 5/10

(52) U.S. Cl. 345/690; 345/77

(57) ABSTRACT

A method enables power savings in an organic light-emitting diode (OLED) display by dimming selected areas of the OLED display pixel by pixel. The selected areas may include, for example, particular displayed objects such as an active window, particular colors, etc. Dimming selected areas of the OLED display results in overall power savings when operating the OLED display.

This application claims priority from U.S. Provisional Patent Application Ser. No. 61/087,632, entitled SELECTIVE DIMMING OF OLED DISPLAYS, filed on Aug. 8, 2008, which is hereby incorporated by reference as if set forth in full in this application for all purposes.

### BACKGROUND

An organic light-emitting diode (OLED) is a light-emitting diode having an emissive electroluminescent layer containing organic compounds. In an OLED display, OLEDs function as picture elements or pixels arranged in a two-dimensional grid or array, where each pixel represents a portion a displayed image. OLED technology is used in display systems such as computer displays, personal digital assistant (PDA) screens, television screens, etc. Unlike liquid crystal displays (LCDs), OLED displays do not require a backlight to function and thus consume far less power than LCDs. However, continual improvements in power efficiency remains desirable, especially as portable computing devices become smaller.

### SUMMARY OF EMBODIMENTS OF THE INVENTION

A method enables power savings in an OLED display by dimming selected areas of the OLED display pixel by pixel. The selected areas may include, for example, particular displayed objects such as an active window, particular colors, etc. Dimming selected areas of the OLED display results in overall power savings when operating the OLED display.

In one embodiment the invention provides a method for implementing a display, the method comprising: selecting a plurality of light-emitting elements in a display based on locations of the light-emitting elements relative to a displayed object; and adjusting a brightness of each of the selected light-emitting elements.

### BRIEF DESCRIPTION OF THE DRAWINGS

FIG. 1 is an example schematic diagram of an OLED array used in an OLED display.

FIG. 2 illustrates an example OLED display showing several objects including an active window.

### DETAILED DESCRIPTION OF THE INVENTION

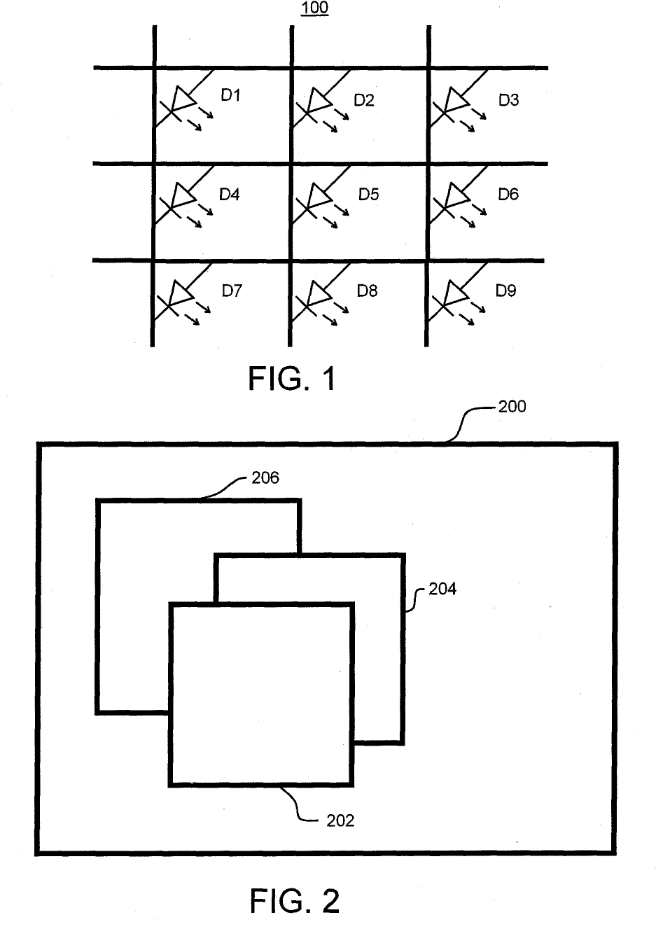

FIG. 1 is an example schematic diagram of an OLED array 100 used in an OLED display. In FIG. 1, OLED array 100 includes a two-dimensional array of OLEDs D1-D9. In a given application, OLEDs D1-D9 function as picture elements or pixels, where each pixel represents a portion of a displayed image or object. Although only a 3×3 array is shown for simplicity, embodiments described herein may be applied to arrays of larger sizes (e.g., 800×600, 1280×720, etc.). OLED array 100 may be used in OLED displays of any type of computing device such as a personal computer, laptop, ultra-portable computer, cell phone, audio player, navigation or location system, or any other device.

The brightness of each of the OLEDs D1-D9 may be controlled (e.g., lowered, raised, or maintained) individually. For example, particular regions of an OLED display may be dimmed pixel by pixel while the brightness of other regions of the OLED display is maintained. A software application stored in a memory or computer-readable storage medium provides instructions that enable a processor to perform these functions and other functions described herein.

FIG. 2 illustrates an example OLED display 200 showing several objects including an active window 202. OLED display 200 also includes inactive windows 204 and 206. In one embodiment, the software application selects OLEDs based on locations of the OLEDs relative to a displayed object such as the active window 202. In one embodiment, the displayed object may be determined by user input. In this example, the user input may be the user clicking on the active window with a mouse. In one embodiment, the software application selects the OLEDs outside of the active window 202. In other words, the software application selects all of the OLEDs that do not generate the active window 202 image. For example, these OLEDs include the OLEDs that generate the inactive windows 204 and 206 and any other objects or desktop objects in the OLED display 200.

The software application then adjusts the brightness of each of the selected OLEDs. More specifically, in one embodiment, the software application dims or lowers the brightness of each of the selected OLEDs. Dimming the inactive windows and other objects results in substantial power savings.

In other embodiments, the software application may select OLEDs based on a variety of criteria. For example, the software application may select OLEDs based on spatial frequency contrast (e.g., all OLEDs except those around textured regions of the display). In one embodiment, the software application may determine the luminance of the each of the OLEDs, compare luminance values of the OLEDs, and identify OLEDs in regions of the display having greater contrast. In one embodiment, the software application may deem these regions of contrast as borders of images and may select OLEDS other than those in these regions to dim. This would reduce overall power consumption while preserving sufficient brightness in these select regions.

In one embodiment, the software application that may select particular OLEDs that generate certain colors or a certain range of colors. For example, the software application may dim OLEDs that produce white, off-white, or light colors, etc. In particular applications such as email applications, where there is black text over a white background, it is not critical that the white background be bright. As such, the software application may select the corresponding OLEDS for dimming.

The embodiments described herein result in lower power consumption, while not compromising the user experience. The lower power consumption is especially beneficial in mobile device applications where improved battery life is highly valued. Furthermore, these embodiments increase the lifespan of OLEDs and OLED displays in general due to the overall decreased usage of the OLEDs.

Although specific embodiments of the invention have been described, variations of such embodiments are possible and are within the scope of the invention.

Any suitable programming language can be used to implement the functionality of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments unless otherwise specified. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. The functions may be performed in hardware, software or a combination of both.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. Functions and parts of functions described herein can be achieved by devices in different places and operating at different times. For example, a processor can perform its functions in “real time,” “offline,” in a “batch mode,” etc. Parallel, distributed or other processing approaches can be used.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the scope of the invention is to be determined solely by the appended claims.

1. A method for implementing a display, the method comprising:
selecting a plurality of light-emitting elements in a display based on locations of the light emitting elements relative to a displayed object; and
adjusting a brightness of each of the selected light-emitting elements.
